(19) United States
(12) Patent Application Publication
(10) Pub. No.: US 2025/0196356 A1
(43) Pub. Date: Jun. 19, 2025

(54) METHOD FOR HANDLING A PIECE OF GOODS

(71) Applicant: Körber Supply Chain Logistics GmbH, Konstanz (DE)

(72) Inventors: Marco Fischer, Konstanz (DE); Richard Huber, Konstanz (DE); Dirk-Udo Eisser, Reichenau (DE); Rolf-Peter Skrdlant, Überlingen (DE); Oliver Schulze, Überlingen (DE)

(21) Appl. No.: 18/978,577

(22) Filed: Dec. 12, 2024

(30) Foreign Application Priority Data
Dec. 13, 2023 (DE) 10 2023 134 878.7

(51) Int. Cl. B25J 9/16

(52) U.S. Cl. CPC B25J 9/1679

(57) ABSTRACT

A method for handling at least one piece good including determining or obtaining at least one piece good information of the at least one piece good, assigning the at least one piece good to a piece good class, wherein the piece good class is obtained from a database based on the piece good information, determining at least one manipulation parameter for the at least one piece good based on the piece good class, and handling the piece good based on the at least one manipulation parameter.

### BACKGROUND OF THE INVENTION

The present disclosure relates to a method for handling at least one piece good. Furthermore, the present disclosure relates to a system and a use for handling at least one piece good.

Various methods are known from the state of the art for handling piece goods with different properties, for example mail items. Different properties include, for example, the weight, shape, dimensions, formability, hardness, material, center of gravity, etc. of a piece good. These different properties mean that not every piece of good can be handled in the same way by means of mechanical manipulation or a mechanical process. Mechanical manipulation means, for example, acceleration or movement on a conveyor belt, gripping by a gripper, such as a vacuum suction gripper, or transportation by a robot.

In known processes, these properties of the piece goods are represented by standardized parameters. However, this can lead to errors, for example during sorting or gripping, or even damage to the piece goods. If errors occur, it may also be necessary for a person to manually intervene in the process.

Therefore, it is an object of the present disclosure to provide a method that enables better handling of piece goods. In particular, it is an object of the present disclosure to provide a method that takes into account the different properties of piece goods.

### SUMMARY OF THE INVENTION

In particular, one aspect of the present disclosure relates to a method of handling at least one piece good, optionally comprising:
determining or obtaining at least one piece good information of the at least one piece good,
assigning the at least one piece good to a piece good class, whereby the piece good class is obtained from a database based on the piece good information,
determining at least one manipulation parameter for the at least one piece good based on the piece good class,
handling of the piece good based on the at least one manipulation parameter.

Compared to the known state of the art, the object of the present disclosure has the advantage that better handling of piece goods is possible. In particular, the error rate in the handling of piece goods is reduced. This means, for example, that in one and/or more operations in which one and/or more piece goods, in particular piece goods with different properties, are manipulated, the number of piece goods in which the manipulation is successful is increased. Furthermore, the present method enables faster manipulation of piece goods and consequently a higher efficiency of piece goods. This can increase the efficiency of processes.

The term “handling” refers to a type of manipulation. For example, it can be understood to mean a change of direction, an acceleration, a gripping process, a picking up, a holding, a releasing, a transport and/or a displacement or movement of a piece good. In particular, the term handling can be understood to mean an action that involves a translational and/or rotational movement of the piece good. Handling can be a physical manipulation of a piece good. The present method may, for example, be used in a system intended to transport and/or sort piece goods. For example, the piece goods can be moved by means of a conveyor belt. It is further conceivable that the method is used in a system comprising grippers, in particular vacuum suction grippers, to handle piece goods. A piece good or an item can be understood to be a transportable good or object, in particular a parcel or package. In particular, pieces of mail or postal items can be understood as piece goods. Piece goods can have various properties or characteristics. The piece goods can have a soft, pliable nature or a firm, unyielding nature. The surface can also be structured or unstructured. Piece goods can also have different packaging properties. A piece good can be essentially symmetrical or asymmetrical in shape. Furthermore, the piece goods can each have different masses. The nature of the piece goods that can be handled in terms of mass and size is defined by the system that is intended to carry out the method according to the invention. For example, a piece good may be understood to be a package made of a cardboard material, for example cardboard, with or without contents. Alternatively, a piece good can be a package or packet made of a film material. Unpackaged piece goods, for example bottles or ampoules, can also be classified under the term piece goods. A piece good class can describe a category for a piece good. In other words, the general cargo class can be a clustering of several pieces of general cargo information. It is conceivable that the general cargo class is a kind of drawer into which similar general cargo information fits. Such a drawer can then be indicative of a certain manipulation parameter. The piece goods information can also be referred to as item information. The piece good class may concern properties relevant to the handling of the piece good. A unit load class can comprise or include at least one piece of unit load information. Optionally, a piece goods class comprises several pieces of piece goods information. For example, piece good information may comprise a geometry of a piece good. In addition, piece good information can include a weight of the piece good. These two pieces of piece good information can then be used to assign a piece good to a piece good class. It is conceivable that a unit load class comprises or contains further, in particular several, unit load information. Furthermore, piece good information can relate to information relating to a recipient of the piece good and/or to a sender of the piece good. In other words, an individual item class may comprise a group of item information. The unit load class can be stored in a database. The database can be stored on a data storage medium. Optionally, the database is stored on a server structure or in a cloud system and can be accessed via this. Alternatively, the database can be stored on a local data storage medium. The unit load classes stored in the database can preferably be changed or adapted. It is particularly advantageous if new unit load classes can be added to the database. The term manipulation parameters refers to parameters that affect the handling of a piece good. For example, manipulation parameters are the parameters with which a handling system that can handle the piece goods can be controlled. In other words, the manipulation parameters can be indicative of how a piece good can be handled. For example, a manipulation parameter may include the speed at which a piece good is transported. Alternatively, a manipulation parameter may comprise a suction pressure of a vacuum suction pad, which is adjusted depending on the class of the piece good. Alternatively, or additionally, the manipulation parameters may include coordinates for gripping a piece good at a specific position or gripping point. Further manipulation parameters can be the power to be applied by a motor or the current applied to a motor, an acceleration, a center of gravity or an angle. The success of handling a piece of good can be advantageously influenced by selecting the appropriate manipulation parameters. The manipulation parameters can also be referred to as the output of the database. A manipulation parameter can, for example, be a setpoint for a control or regulation system configured to handle the at least one piece good. Optionally, the determining of the at least one manipulation parameter may be performed based on a desired result of a manipulation to be performed. the desired result may comprise, for example, a probability of success of the manipulation. In other words, the determination of the at least one manipulation parameter can take into account how certain the manipulation is to be successful. This means that a particularly high probability of success can be set for very sensitive piece goods in order to avoid damage. Furthermore, the desired result can, for example, be indicative of the handling of two piece goods at the same time. The manipulation parameters can be adjusted accordingly so that this is achieved. Furthermore, the desired result can be indicative of particularly precise handling of the piece goods. This can be particularly advantageous if the placement of the piece good in the room at a certain position is particularly important. In addition, or alternatively, the desired result can be indicative of a speed for handling the piece good. This can be used to determine whether the piece good should be handled particularly slowly or particularly quickly. Overall, the desired result can be used to further influence at least one manipulation parameter. This means that the method can be particularly well adapted to individual handling processes.

Optionally, the database is a multidimensional database, and the assignment of the at least one piece good to the piece good class is performed based on at least two pieces of piece good information. Optionally, the assignment of the at least one piece good is carried out based on at least three pieces of piece good information. For precise handling, it is advantageous if as much piece good information as possible is determined about the individual piece goods. This can prevent or reduce incorrect sorting, disruptions in the transport of piece goods or even damage to the system. A multidimensional database (MDB) can be a database concept in which the data is stored in several dimensions. It is not limited to two dimensions, like a relational database, but to several dimensions. In a multidimensional database, each individual data value can be stored in a single data cell. The data cells are not only arranged in two dimensions, as in a relational database, but in a multidimensional matrix or array. The number of dimensions of a multidimensional database is determined by the types of information stored in the database. Here, information can be understood as piece goods information. For example, the shape, weight and surface properties of one or more piece goods can be determined. Such a multidimensional database, which takes this piece goods information into account, therefore comprises three dimensions. A three-dimensional database can be represented as a cube, for example. Depending on the content of the individual piece good information, the piece good can be assigned to a corresponding piece good class. For example, a first piece good and a second piece good can be identical or at least almost identical in shape and surface quality, but differ significantly in weight. The first piece good is then assigned to a different piece good class than the second piece good. This makes it possible for the two piece goods to be handled with manipulation parameters that are adapted to their weight in particular.

In contrast to a multidimensional database, a relational database works two-dimensionally with tables consisting of columns and rows in which it stores the data. Accessing the data requires complex combinations of many tables. Presentation and navigation in multidimensional databases follow an intuitive work process. Data analysis and decision-making are therefore much simpler and more efficient with multidimensional databases. Multidimensional databases are particularly advantageous for decision-making processes in interactive analyses of large amounts of data. They can be used particularly advantageously to utilize large volumes of data directly for logistics and/or for further planning. In other words, input data (e.g., general cargo information) can be fed into the multi-dimensional database. The multi-dimensional database can then output data (e.g., unit load class). The multi-dimensional database has the advantage that, for example, a variety of piece goods information can be provided as input data and the multi-dimensional database can still take all piece goods information into account in order to determine a piece goods class as output data. Thus, it is possible to satisfactorily classify a very wide range of different piece goods. For the present disclosure, it is advantageous to provide a multi-dimensional space which can receive item information and possibly a desired result as input data and can output at least one manipulation parameter from output data.

Optionally, several piece goods with the same or similar piece good information can be assigned to the same piece good class. This can reduce the number of required unit load classes in the database. A tolerance or deviations in the properties of the piece goods, for example in the shape, mass and/or size of piece goods, can be taken into account. In particular, unit load classes can include or cover ranges or areas of unit load information.

Optionally, the manipulation parameters are identical for all piece goods in a piece goods class. This ensures that the piece goods in a piece goods class are always handled in the same way. Errors in handling the piece goods can thus be avoided or reduced.

Optionally, the determination or obtaining of at least one piece good information of the at least one piece good takes place at a time before the handling of the piece good based on the at least one manipulation parameter. In this way, the piece good information required to determine the manipulation parameters and to handle the piece goods safely can be provided in good time. For example, the piece goods information can be obtained using sensors or provided by a database.

Optionally, the piece good information comprises at least one parameter about a past manipulation and/or a past manipulation attempt of the same piece good or a similar piece good, in particular a mail item. A past manipulation can be given, for example, if a piece good with certain properties has already been handled before by a handling device. This previous handling may have been analyzed and information about it may be stored. For example, the handling of a shipping bag with a suction gripper can be analyzed and it can be determined at what speed the shipping bag falls off the suction gripper and when it does not. This information can then be stored in the database. If the same or a similar shipping bag is then detected again by a handling device, the stored information can be retrieved and used for the current control of the handling device. The same or a similar piece good can optionally be assigned to the same piece good class. In particular, the parameter relating to a previous handling attempt can include an acceleration, a gripping point, a vacuum pressure and/or a pressure loss.

The piece goods information optionally includes the success of a previous tampering attempt, in particular by comparing the expected and actual result. The success or failure of a manipulation or handling is optionally recorded and stored in the database if necessary. This allows the manipulation parameters to be adjusted if necessary. For example, the manipulation parameters can be adjusted automatically or by human intervention. In this way, the process can be adaptable. For example, if the existing parameters indicate that handling can be successful with certain manipulation parameters, but this has failed in the past, this can be stored in the database and the manipulation parameters can be adjusted accordingly. This allows the process to learn on the basis of “experience”.

Optionally, the piece good information includes a deformation of the piece good during handling. For example, this can be used to detect whether the piece good has been damaged. Further piece good information can also be determined in this way with regard to the material properties of the piece good. The deformation of the piece goods can be determined optically, for example using an optical sensor. Deformation of the piece goods can occur, especially with flexible packaging of the piece goods. For example, a planned gripping point of a piece good may be well suited in an undeformed state. However, if contact occurs between the handling device and the piece good, the piece good may deform in such a way that the previously targeted contact point may be disadvantageous. The information about the deformation of the piece good means that such a circumstance can be taken into account and the gripping point or the handling of the piece good can be adapted accordingly.

Optionally, the piece good information comprises a motor current of a handling device when handling the piece good. This allows the power required to handle a piece good of a certain class to be stored as a manipulation parameter. It is also possible to deduce the mass of the piece good. Furthermore, a center of gravity of the piece good can be inferred (in conjunction with an optical analysis system). This allows an actual measurement of at least one property (i.e., piece good property) of the piece good to be carried out.

Optionally, the piece good information comprises sensor data from a sensor of a handling device when handling the piece good. For example, the sensor data can be provided by a distance sensor, an optical sensor and/or a pressure sensor. The position of a piece good, for example on a conveyor belt or a shelf, can be determined by a distance sensor and provided for assigning the piece good to a piece good class. Optical sensors, such as camera sensors or laser sensors, are suitable both for detecting piece goods and for measuring distances. Pressure sensors can provide data relating to the holding force required for a piece good.

Optionally, the general cargo information includes sender and/or recipient information. This makes it possible to assign the piece goods to a piece goods class, taking into account the origin and destination. For example, the storage location from which the piece goods were taken can be stored on the piece goods as sender information and the destination, for example for further processing of the piece goods, can be stored on the piece goods by the recipient information. In particular, the piece goods can be postal items. In particular, the recipient and sender information can be stored or arranged on the piece goods as a barcode. This means that they can be easily read and used to assign the piece goods to a corresponding piece goods class. Alternatively, an image-based technology for recognizing letters or parcels based on their optical properties can be provided. Such image-based technology, also known as fingerprint technology, is not dependent on labels and barcodes.

Optionally, the piece good information includes database information and/or posting documents about the content or weight of the piece good. In this way, piece good information that is received when the piece good is posted or recorded can be used when assigning the piece good to a piece good class. For example, the weight of a piece of mail that was measured when it was posted can be stored as piece goods information in this way. In particular, if a delivery of piece goods is announced and information about the piece goods is available, information about the piece goods can be obtained before the piece goods are handled. This can facilitate the classification and handling process.

Optionally, the method also includes the step of adding piece good classes to the database, in particular after handling the piece good. For example, if a piece good is not handled successfully, a new piece good class can be created based on the piece good information. The new piece good class can then be indicative of manipulation parameters that should allow a previously handled piece good to be handled without error in the future. This is particularly advantageous if piece goods information does not match existing piece goods classes. This makes it possible to dynamically adapt the database. In particular, the database can be adapted manually or automatically in this way and thus improved. The database, in particular the multidimensional database, can be adapted using machine learning or artificial intelligence.

Optionally, piece good information is obtained from a later identification of the piece goods. Optionally, the piece goods can be identified by means of a scale and/or by means of recipient and/or sender information. This means that even after the piece goods have been handled, information about the handled piece goods can be obtained and stored in the database. This can increase the quality of the information stored in the database. Furthermore, the manipulation parameters can be optimized to make handling even more efficient.

Optionally, in the further course of handling the piece good, the piece good is tracked and thus at least one piece of piece good information is obtained, in particular mass, dimensions and/or behavior during handling of the piece good. For example, this piece goods information can be determined during handling and used for the further course of handling. It is therefore advantageous if an assignment between piece goods information and piece goods classes is realized based on data obtained in the past, in particular during the operation of a system. For example, the piece goods can be tracked using radio frequency identification (RFID). It is also conceivable to track a piece good using optical methods during subsequent handling. This makes it possible to determine how a particular piece good behaves in other handling devices. This allows further conclusions to be drawn about the item information. For example, it is possible to track how the mail item behaves when it is shot onto a sorter during a subsequent high-speed injection. Such information can be used to improve future handling of the mail item, as it is possible, for example, to recognize how quickly a mail item can be accelerated. Furthermore, subsequent handling devices can record measured variables of the mail item based on the type of handling and make them available to the database.

Optionally, the piece good information is determined based on an image of the piece good. In other words, it may be sufficient to obtain a single image of the piece good in order to assign it to a piece good class. The optical recording of an image can be particularly simple. Furthermore, an image can also be captured by a device that is spaced apart from the handling device. This means that the acquisition of the image and the handling device can be independent of each other. This means that the image capture system can also be provided subsequently. Furthermore, the above method can also be used for existing systems. For example, images of a piece good can be taken before handling and after handling. Piece good information can then be determined based on a comparison of the images of the piece good. In particular, the external condition of the piece good before and after handling can be taken into account.

Optionally, a learning algorithm can be used to determine the piece goods information based on an image. The learning algorithm can be used to extract image information from the image. The algorithm may have been trained with a plurality of images of piece goods as input data and with information about what type of piece good is shown in the image as output data. This allows the algorithm to recognize in real time what is shown on the respective image.

Optionally, an accuracy of the determined piece good information is determined based on a successful handling of the piece good. In this way, it can be defined that the manipulation parameters used are suitable for handling. In the next step, the manipulation parameters can be adjusted and checked to see whether the handling is still successful. In this way, the optimum manipulation parameters for each unit load class can be obtained by iterative approach. This allows the handling of piece goods to be optimized further and further (e.g., for each piece good class).

Optionally, the piece good information includes a probability of successful handling of the piece good with the assigned manipulation parameters. Failed manipulations can thus be taken into account. Furthermore, the manipulation parameters can be adjusted if there is a deviation between an expected number of failed manipulations and an actual number of failed manipulations. Alternatively or additionally, a probability of success can be used as the basis for determining the at least one manipulation parameter.

Optionally, the assignment of item information and item class and/or the assignment of item class and manipulation parameters is updated, in particular at regular intervals. In particular, manipulation parameters can be set or changed to predetermined values and a handling success of the at least one piece good can be determined. An exploration phase can be provided in which various manipulation parameters are initially tested. For example, it is advantageous if manipulation parameters are adjusted in certain increments and a handling success of the at least one piece good is determined. The manipulation parameters can be adapted based on the exploration phase and/or a handling success and stored in the database. Additionally, or alternatively, an accuracy of a handling of the piece good can be determined with the assigned manipulation parameters.

It is advantageous if a number of piece good classes are defined so that all piece goods to be handled can be handled successfully. This ensures successful handling if, for example, a piece good cannot be clearly assigned to a piece good class.

Optionally, a range is determined for the at least one manipulation parameter at which successful manipulation of the piece good is expected. For example, the range may include a speed range for moving a piece good to a desired position in a certain time. A quality parameter is assigned to at least one manipulation parameter so that the manipulation parameter can be weighted in order to achieve the greatest possible handling success. The success and failure of the handling as well as the probability that a piece good will be damaged during handling can also be taken into account.

According to a further aspect of the present disclosure, there is provided a system for handling at least one piece good, the system comprising: at least one transport device for handling piece goods, and a sensor unit adapted to carry out the method according to any one of the preceding claims.

Another aspect of the present disclosure relates to a system comprising at least one transportation device for handling piece goods, wherein the system is configured to perform the method according to any one of the preceding claims.

The system optionally includes an optical sensor, in particular a camera. This allows optically recognizable properties of the piece goods, such as surface condition, stamps and logos, as well as size, volume and weight to be detected or determined and piece good information to be derived from this. Alternatively or additionally, the system can include a laser sensor, in particular a laser raster.

The term transport device is to be understood broadly. In particular, it can be understood to mean a device that actively manipulates a piece good. This means, for example, that the transport device impacts or moves the piece good with a force. A transport device can be, for example, a conveyor belt, a vacuum suction gripper or similar.

In particular, the system can include a cross-belt sorter as a transport device. The cross-belt sorter comprises several cross-belt elements, which are arranged one after the other and move piece goods in a longitudinal direction or transport direction. The transverse belt elements each comprise a running belt orthogonal to the transverse direction. The running belt makes it possible to discharge piece goods from the cross-belt element. For example, the speed of the cross belts or the running belts can be adjusted as a manipulation parameter depending on the piece good class of a piece good in order to successfully discharge it. The crossbelt sorter is particularly suitable for light and bulky parcels. In addition, the crossbelt sorter can include a device that uses blasts of compressed air to convey misplaced piece goods to an end point. For example, the pressure and duration of the compressed air blasts can be adjusted.

In particular, the system can also include a singulator as a transport device. The singulator is intended to convert a volume flow of piece goods into a flow of individual piece goods. The singulator comprises, for example, a section with narrow conveyor belts that are arranged in a matrix in the direction of travel and that can be controlled individually. The individual conveyor belts can be activated and the speed controlled depending on the size of the piece goods or the piece goods class in order to arrange the piece goods offset from each other in the direction of travel. An alignment unit is also arranged on this section in the direction of travel, which aligns the piece goods in a row. For this purpose, the aligner comprises rollers arranged at an angle to the direction of travel, which move the piece goods in the direction of travel and in the transverse direction if they are arranged one behind the other.

The system can include a vacuum suction gripper as a transport device. The vacuum suction gripper is suitable for gripping various piece goods with different properties such as size, shape, weight, surface finish, etc. and moving them from a starting position to an end position. The vacuum gripper is optionally arranged downstream of the singulator in the operating direction.

Gripping is performed by a vacuum. The pressure difference is created by forming a vacuum between the suction pad and the piece good. More precisely, as soon as the suction pad touches the surface of the piece good and seals the surface from the environment, a vacuum is created. The holding force depends on the pressure difference between the ambient pressure and the pressure in the suction pad and on the size of the contact surface between the vacuum suction pad and the piece good. This means that a suitable suction pressure can be selected as a manipulation parameter depending on the piece good class to which the piece good is assigned. A gripping point or a suction point can be specified as a further manipulation parameter depending on the shape of the piece good assigned to the piece good class.

The system can comprise one or more rows of rollers as a transport device. The roller rows can, for example, feed piece goods onto a conveyor belt or divide them into different piece goods streams. It is therefore advantageous to arrange the rows of rollers in the operating direction downstream of the singulator. More specifically, the rows of rollers are advantageously used to divide a flow of piece goods downstream of the singulator. An automatic sensor system can determine the exact position and size of the piece goods using a light grid or a camera, for example. The piece goods can thus be assigned to the corresponding piece goods classes and accelerated with a corresponding manipulation parameter and/or the orientation of the rolls can be adjusted, for example to feed the piece goods to a sorting system carrier.

The system can include a belt conveyor as a transport device. Belt conveyors are advantageous for transporting large volume flows of piece goods. For example, belt conveyors in the system must be designed in such a way that they can handle a wide variety of transport loads with high availability and reliability at the same time. Belt conveyors can precisely position and sort piece goods with high frequency and short acceleration and braking distances. Depending on the piece good class, i.e., the properties of the piece goods to be transported, the speed of the belt conveyor can be regulated, for example.

According to another aspect of the present disclosure, there is provided a use of the system according to the above embodiment for handling piece goods.

A further aspect of the present disclosure relates to a use of a transport device, in particular a singulator, and/or a gripper, in particular a vacuum suction gripper, in a method according to one of the preceding embodiments.

According to an aspect of the present disclosure, there is provided a method of handling at least one piece good comprising recording piece good information. The piece good information may be collectable parameters of the piece good and/or of a previous manipulation attempt of the piece good. In particular, the item information can include item properties, an image of the item, sensor data during the manipulation attempt and/or a result of the manipulation attempt (e.g., success/failure, duration and/or other costs, e.g., power consumption or wear and tear). A database can be created based on the unit load information. The database can be indicative of how which piece good must be handled in order to obtain a certain result.

The method can also include refactoring the database in order to increase the efficiency of an application of the database. Optionally, several entries can be clustered according to the same successful manipulation parameters. Such a clustering can then be referred to as a piece goods class. In other words, different manipulation parameters (which, for example, have delivered a certain result in the past) can be assigned to a unit load class. In addition or alternatively, entries can be clustered according to similar general cargo properties (e.g., consignment properties). In other words, different unit load properties (which require similar manipulation parameters, for example) can be assigned to a unit load class. Based on this, a database can be realized that is similar to a function that records shipment properties and outputs manipulation parameters.

Furthermore, the method can include continuous optimization of the database. In other words, continuous optimization of the derived data structure can be implemented when new data points are added. This means that the method can also be used to advantage when a spectrum of items changes over time.

Furthermore, the method can determine a probability of success for each proposed manipulation parameter. Optionally, the aim can be to achieve the highest possible probability of success for each proposed manipulation parameter. In this way, error-free manipulation of the piece good can be realized with a high probability.

Optionally, the method comprises an exploration in which unknown piece goods are recognized and handled with predetermined manipulation parameters. In other words, unknown piece goods may be piece goods for which there is no or very little experience from previous manipulations. In such cases, the database cannot provide a satisfactory suggestion for manipulation. This may be because manipulation with this type of piece good has never been tried before. In such a case, predetermined manipulation parameters can be used to ensure that the piece good is manipulated safely. For example, the piece good can be handled particularly slowly to prevent an error from occurring during manipulation. Manipulation during exploration can be monitored in detail to check the manipulation parameters applied. The manipulation parameters can then be adjusted step by step to find the optimal manipulation parameters for that type of piece good and/or class of piece goods. Once the optimum manipulation parameters have been found, the exploration can be ended.

Thus, a multidimensional space can be created that includes a variety of possible piece goods and manipulation parameters. In other words, the multidimensional space can output the manipulation parameters required for certain piece goods information. However, a history (e.g., information on past handling) does not necessarily have to be stored in a multidimensional database.

Individual features or embodiments can be combined with other features or other embodiments to form new embodiments. The advantages and embodiments mentioned in connection with the features or embodiments then apply analogously to the new embodiments. Advantages and embodiments mentioned in connection with the method also apply analogously to the device and vice versa.

### BRIEF DESCRIPTION OF THE DRAWINGS

Further advantages and features of the subject matter of the present disclosure are shown in the following description with reference to the figures. Individual features of the embodiments shown can also be used in other embodiments, unless this has been expressly excluded. It shows:

FIG. 1 is a schematic view of an embodiment of the method according to the invention;

FIG. 2 is a schematic view of a system; and

FIG. 3 is a schematic representation of a multidimensional database.

### DETAILED DESCRIPTION OF THE PREFERRED EMBODIMENTS

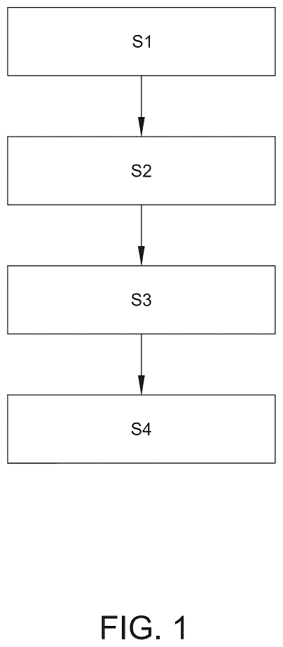

FIG. 1 shows a schematic representation of an embodiment of a method for handling at least one piece good. In a first step S1, at least one piece good information SI of the at least one piece good is determined or obtained. This can be carried out, for example, by a sensor unit 12. The sensor unit 12 can, for example, be an optical sensor, in particular a camera. Alternatively, the item information SI may have already been recorded and stored at an earlier time, so that it only needs to be retrieved from a database. Optionally, at least three items of item information SI are recorded, which are optionally stored in a multidimensional database.

In a second step S2, the at least one piece good is assigned to a piece good class SK, the piece good class SK being obtained from a database DB based on the piece good information SI. In other words, a piece good is assigned as a function of the piece good information SI. The database can be a multidimensional database or comprise at least one multidimensional database. In particular, the types of item information SI define the number of dimensions of the multidimensional database.

In a third step S3, at least one manipulation parameter for the at least one piece good is determined based on the piece good class SK. This means that at least one manipulation parameter is assigned to a unit load class SK.

The manipulation parameters can also be referred to as the output of the database DB. For example, a manipulation parameter may be a setpoint for a controller configured to handle a piece good. For example, the setpoint may include a suction pressure for a vacuum gripper. In addition, the setpoint may include a speed and/or acceleration for a robot arm of the vacuum gripper. For example, a low speed and a high suction pressure can be provided for a piece good class in which particularly heavy and/or unwieldy piece goods are included in order to handle a piece good. For particularly light piece goods, for example, a lower suction pressure and a higher speed can be provided.

In a fourth step S4, the piece good is handled based on the at least one manipulation parameter. In other words, the manipulation parameters provided or stored for a unit load class are retrieved and used. The manipulation parameters can be transmitted to control units or regulating units in order to control the devices that handle the piece goods according to the piece goods class.

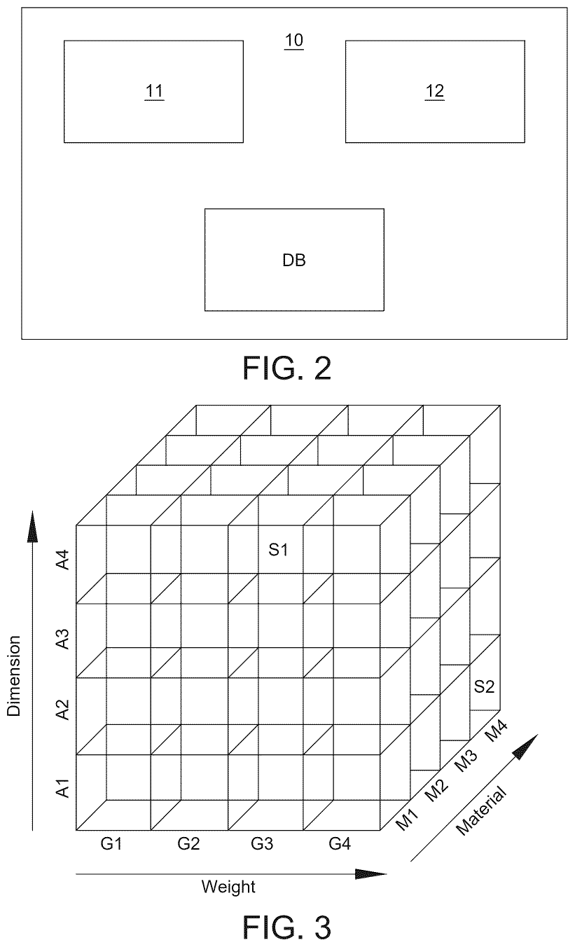

FIG. 2 shows a system 10 which is provided for carrying out said method. The system 10 comprises at least one transport device 11 and a sensor unit 12. The system 10 further comprises the database DB.

The transport device 11 is configured to manipulate and/or move piece goods. It is conceivable that the system 10 comprises several different transport devices 11 which are connected or coupled to one another in order to handle the piece goods, in particular to transport and/or sort them.

The sensor unit 12 can be integrated into the transport device 11. The sensor unit 12 is configured to detect piece good information SI of the piece goods. For this purpose, the system 10 can comprise several different sensor units 12. In particular, the sensor unit 12 can comprise an optical sensor. In particular, laser sensors can be used. These are advantageous for determining the dimensions of a piece good. Camera sensors can also be used. These are advantageous for detecting optical properties of the piece goods. A scale for determining the weight of the piece goods can also be provided.

The database DB can be a multidimensional database. The database DB is connected to the sensor unit 12. The piece goods information SI determined by the sensor unit 12 is transmitted to the database DB. In the database DB, the piece goods are assigned to piece good classes SK on the basis of their piece good information SI. This results in manipulation parameters for the individual piece goods, which are sent to the transport device 11 in order to handle the piece goods.

FIG. 3 schematically shows a multidimensional database. The multidimensional database shown comprises three dimensions and is represented as a cube.

A dimension Y comprises dimensions of a piece good, a dimension X comprises a weight of a piece good and a dimension Z comprises a material of a piece good.

Dimension Y comprises several dimensions or several ranges of dimensions of the piece good such as height, width, depth, radius and/or angle. To obtain these, the piece good can be scanned or scanned by a laser sensor. The dimensions can optionally be used to detect the shape and volume of the piece good.

Dimension X comprises the weight that was recorded, for example, by weighing the piece good. This piece good information makes it possible to determine the force required to set a piece good in motion. This means, for example, that the power required for a motor can be predetermined and output as a manipulation parameter. Furthermore, the weight in combination with the dimensions can be used to calculate a center of gravity of the piece good. This can be helpful in determining the coordinates of a position for attaching a gripper, in particular a vacuum suction gripper, to the piece good.

Dimension Z concerns the material of the piece good. Dimension Z contains the information as to whether the piece good is made of a hard or rigid material or a soft, flexible material. Dimension Z can also include piece good information as to whether the piece good has a rough or smooth surface. This information can be advantageous when handling the piece good with a vacuum suction pad. This allows the suction pressure to be adjusted using a suitable manipulation parameter.

For example, a first piece good S1 has the piece good information A4, G2 and M1. The piece good S1 is assigned to the corresponding piece good class SK. The unit load classes are represented by the partial cubes. If the first piece good S1 is assigned to the piece good class, the manipulation parameter defined for this piece good class SK can be retrieved or the defined manipulation parameters can be retrieved.

A second piece good S2 has the piece good information A1, G4 and M4. The second piece good S2 is assigned to a different piece good class SK than the first piece good S1, as the piece good information SI differs from one another. Consequently, different manipulation parameters are assigned to the second piece good S2 than to the first piece good S1.

It is conceivable that piece good information is weighted differently depending on the type of device handling the piece goods. For example, the weight of a piece good may be more important when handling with a vacuum suction gripper than when transporting a piece good through a singulator or conveyor belt.

In addition to the three dimensions of the multidimensional database mentioned above, it is conceivable that a fourth dimension exists. A fourth dimension can, for example, be information relating to the sender and/or recipient, such as a zip code for parcels. The multidimensional database can comprise any number of dimensions.

It is also conceivable that several multidimensional databases are linked together. This allows a large amount of unit load information to be processed quickly and efficiently.

Alternatively, or additionally, the item class SK determined by the item information SI can form a separate dimension of a further multidimensional database. This allows the piece goods to be further subdivided and processed.

Other embodiments of the present disclosure are possible and can be understood and carried out by persons skilled in the art when using the claimed subject matter from studying the figures, the disclosure and the appended claims. In particular, the respective parts/functions of the respective embodiment described above can also be combined with each other. Further, various steps of the method may be performed in a different order than disclosed herein. In the claims, the word “comprising” does not exclude other elements or steps and the indefinite article “one” or “a” does not exclude a plurality. The mere fact that certain measures are recited in interdependent claims does not mean that a combination of these measures cannot be advantageous. Any reference signs in the claims should not be construed as limiting the scope of the claims.

### REFERENCE SIGN LIST

SI Piece good information
SK Piece good class
DB Database
10 System
11 Transport device
12 Sensor unit

The invention claimed is:

1. A method for handling at least one piece good, comprising:
determining or obtaining at least one piece good information of the at least one piece good;
assigning the at least one piece good to a piece good class, whereby the piece good class is obtained from a database based on the piece good information;
determining at least one manipulation parameter for the at least one piece good based on the piece good class; and
handling the piece good based on the at least one manipulation parameter.

2. The method according to claim 1, wherein the database is a multidimensional database, and wherein the assignment of the at least one piece good to the piece good class is carried out based on at least two piece good information items.

3. The method according to claim 2, wherein, during the assignment, several piece goods with the same or similar piece goods information are assigned to the same piece goods class.

4. The method according to claim 3, wherein manipulation parameters are identical for all piece goods of a piece goods class.

5. The method according to claim 4, wherein the step relating to determining or obtaining at least one piece good information of the at least one piece good occurs in time before the step relating to handling the piece good based on the at least one manipulation parameter.

6. The method according to claim 5, wherein the piece good information comprises at least one parameter about a past tampering and/or a past tampering attempt of the same piece good or a similar piece good.

7. The method according to claim 6, wherein the same piece good or similar piece good includes a mail piece.

8. The method according to claim 6, wherein the piece goods information comprises success of a previous tampering attempt.

9. The method according to claim 8, wherein the success of a previous tampering attempt is determined by a comparison of an expectation and an actual result.

10. The method according to claim 8, further comprising:
adding piece good classes to the database.

11. The method according to claim 10, wherein the adding piece good classes to the database is completed after handling of the piece goods.

12. The method according to claim 1, wherein, during the assignment, several piece goods with the same or similar piece goods information are assigned to the same piece goods class.

13. The method according to claim 1, wherein manipulation parameters are identical for all piece goods of a piece goods class.

14. The method according to claim 1, wherein the step relating to determining or obtaining at least one piece good information of the at least one piece good occurs in time before the step relating to handling the piece good based on the at least one manipulation parameter.

15. The method according to claim 1, wherein the piece good information comprises at least one parameter about a past tampering and/or a past tampering attempt of the same piece good or a similar piece good.

16. The method according to claim 15, wherein the same piece good or similar piece good includes a mail piece.

17. The method according to claim 1, wherein the piece goods information comprises success of a previous tampering attempt.

18. The method according to claim 17, wherein the success of a previous tampering attempt is determined by a comparison of an expectation and an actual result.

19. The method according to claim 1, further comprising:
adding piece good classes to the database.

20. A system for handling at least one piece good, comprising:
at least one transport device for handling piece goods; and
a sensor unit configured to carry out the method according claim 1.
